(19) United States
(12) Patent Application Publication
(10) Pub. No.: US 2023/0001641 A1
(43) Pub. Date: Jan. 5, 2023

(54) STOCK FEEDING DEVICE

(71) Applicant: FRAUNHOFER-GESELLSCHAFT ZUR FÖRDERUNG DER ANGEWANDTEN FORSCHUNG E.V., München (DE)

(72) Inventors: Jana KELBASSA, Aachen (DE); Andres GASSER, Aachen (DE); Thomas EBERT, Stolberg (DE); Bastian KOSTELNIK, Aachen (DE)

(21) Appl. No.: 17/760,751

(22) PCT Filed: Sep. 8, 2020
(86) PCT No.: PCT/EP2020/075065

§ 371 Date: Mar. 15, 2022

(30) Foreign Application Priority Data
Sep. 16, 2019 (DE) 10 2019 124 856.6

(51) Int. Cl. B29C 64/321; B23K 26/144; B33Y 10/00; B33Y 40/00; B33Y 50/00; B28B 1/00; B22F 10/28; B22F 10/80; B22F 12/90; B22F 12/50; B29C 64/153; B29C 64/386

(52) U.S. Cl. CPC B29C 64/321; B23K 26/144; B33Y 10/00; B33Y 40/00; B33Y 50/00; B28B 1/001; B22F 10/28; B22F 10/80; B22F 12/90; B22F 12/50; B29C 64/153; B29C 64/386; B23K 26/1482

(57) ABSTRACT

The invention relates to a material feeding device. The material feeding device according to the invention to be used in a material processing device has a material feeding channel with an output end facing a processing site during operation of the material feeding device, and is characterized in that the material feeding device has at least one microchannel.

The invention relates to a material feeding device. In particular, it relates to a device for feeding in materials for material processing methods, for instance for feeding in a filler material.

Material processing methods can be, for instance, laser material processing methods. In many laser material processing methods (e. g. cutting, welding, build-up welding, soldering), the actual material or filler material must be fed to the processing site so as to either provide filler material or influence the process by means of gases. These methods comprise, e. g., laser soldering (hard- and soft-soldering), welding of plastics, welding of metal materials, application of layers made of metal, ceramics or plastics, generating structures made of metal, plastics or ceramics, laser beam cutting, laser beam curing, laser beam alloying, laser beam dispersion, to name the most important ones. The use of laser beams, however, is not absolutely necessary in the material processing method; another example of material processing methods could be arc welding.

Material as such must be fed in, for instance, in generative manufacturing. Here and in the following, the terms “material” and “filler material” will be used synonymously and designate in each case a material which is fed or must be fed to a processing site. The material can be supplied in solid, liquid or gaseous form. In solid form, it is mostly a wire or a powder.

Material processing devices for performing material processing methods are well-known. They can have at least one energy production device, for instance a laser for connecting cooling media and protective gas, as well as conducting devices for these media, and furthermore a feeding device for the material to be fed to the processing site. Such devices commonly have a processing head with a nozzle-type geometry on its side facing the processing site. Since commonly inert gas can be fed to the processing site through the nozzle-type geometry of the processing head, this part of the processing head is also called inert gas nozzle. Material processing devices in which the material is fed from the side are also known. Due to its size, however, such an arrangement is rather a nuisance in the vicinity of the processing site. In addition, this arrangement is asymmetrical so that if the feeding direction is altered in following a contour of a workpiece, a rotation of the processing head having a material feeding device, an optical system for beam guidance and forming, possibly a cooling device and possibly an inert gas feeding device becomes necessary. Otherwise, the process is dependent on direction.

If the material is to be fed in centrally, i. e. axially to the longitudinal axis of the processing head, the laser beam(s), if any, must be divided such that the central axis becomes or remains free for material feeding. The material must be fed to the processing site, that is, the site where the laser beam(s) impinge(s) upon the substrate. Normally, the respective processing heads have the shape of a nozzle, the fed material as well as the laser beam and any protective gas and any cooling media to be supplied being conducted through the processing head. The components must be embodied and the laser beam(s) must be conducted such that the beam guidance is not impaired, in particular, such that the beam(s) is or are not shielded off. From German patent DE 10 2007 018 400 B4, an optical system and a respective processing head are known by means of which the material can be axially guided to the processing site whereas the laser beam is divided in annular form and can be guided coaxially to the processing site.

During this laser material processing, the material feeding device heats up due to scattered radiation from the optical system, heat radiation from the process and reflected laser radiation. If laser material processing is also to be performed in hard-to-access sites of a workpiece, the nozzle must be correspondingly small. Limitation of the available space in the processing head commonly allows for the axial material feed to be performed without direct cooling. Heating up of the material feeding device leads to process cutoff by failure of the system. Longer processing times or the use of greater laser power which would be necessary, for instance, to increase the application rate, are not possible in this manner. For instance, overheating of the material feeding device occurs at laser powers less than 1000 W and process times longer than 15 min.

The process of laser build-up welding is today interrupted at regular intervals and cooling times are observed in order to avoid damage of the material feeding device and/or overheating of the material feeding device and related problems in material feeding. Alternatively, the operating distance between material output opening and processing plane can be increased which, however, leads to less precise guidance of the filler material to the weld pool and consequently to instability of the process. For wire-shaped materials with a diameter less than approximately 0.8 mm, for instance, an increase in the operating distance is not desirable since precise guidance and positioning of the material with respect to the weld pool would no longer be guaranteed.

It is known to provide welding torches for arc welding processes with water cooling. The dimensions for water cooling requiring approximately 25 mm outer diameter and more, however, do not allow for integration in a miniaturized processing head with axial material feeding; that is, they necessitate substantial enlargement of the processing head with significantly less accessibility, which is unfavorable. Using conventional manufacturing methods, no water cooling can be integrated in material feeding nozzles with an outer diameter of 8 mm or less.

It is the task of the invention to disclose a material feeding device for performing a laser material processing method which minimizes the described disadvantages of the state of the art. Another task is to disclose a manufacturing method for such a material feeding device.

The first task is achieved by means of a material feeding device according to the independent claim 1. Advantageous further developments of the material feeding device follow from claims 2 through 10. The second task of the invention is achieved by a manufacturing method according to the independent claim 11. An advantageous further development of the manufacturing method follows from claim 12.

The material feeding device according to the invention, to be used in a material processing device, has a material feeding channel with an output end facing a processing site in operation of the material feeding device; characterized in that the material feeding device has at least one microchannel.

Some terminology will be explained in the following:

In this document, a material feeding device to be used in a material processing device is understood to be a device by means of which a material can be fed to a processing site on a substrate. In particular, the material feeding device can be employed in a material processing device which uses a laser material processing method.

Material processing devices for performing material processing methods are well-known. They can have at least one energy production device, for instance a laser, as well as ports for connecting cooling media and protective gas as well as conducting devices for these media and beams and in addition a feeding device for the material to be fed to the processing site. Such devices commonly have a processing head with an inert gas nozzle on its side facing the processing site. Material processing devices in which the material is fed from the side are also known. In such lateral feeding, the feeding axis has an angle of more than 0° and less than 90° with respect to the axis of a beam guide. Due to its size, however, such an arrangement is rather a nuisance in the vicinity of the processing site. In addition, this arrangement is asymmetrical so that if the feeding direction is altered in following a contour of a workpiece, a rotation of the processing head having a material feeding device, an optical system for beam guidance and forming, possibly a cooling device and possibly an inert gas feeding device becomes necessary. Otherwise, the process is dependent on direction.

If the material is to be fed in centrally, i. e. axially to the longitudinal axis of the processing head, the laser beam(s), if any, must be divided such that the central axis becomes free for material feeding. The material must be fed to the processing site, that is, the site where the laser beam(s) impinge(s) upon the substrate. Normally, the respective processing heads have the shape of a nozzle, i. e. an inert gas nozzle, the fed material as well as the laser beam and any protective gas and any cooling media to be supplied being conducted through the processing head and in particular the inert gas nozzle. The components must be embodied and the laser beam(s) must be conducted such that the beam conducting is not impaired, in particular, such that the beam(s) is or are not shielded off.

The term laser material processing method is to be understood in its broadest sense, comprising all material processing methods, such as cutting, welding, build-up welding, soldering, in which a laser beam is employed. Laser beams are electromagnetic waves with high intensity, often a very small frequency range, strong focusing of the beam and large coherence length. The material can be fed in solid or liquid form or as a gas. In solid form, the material is generally a wire or a powder.

In this document, the term material feeding channel designates a channel through which the material can be fed to the processing site. The material feeding channel can have any cross-section, including an annular cross-section.

The term optical channel in this document in particular designates a channel through which a laser beam can be conducted to the processing site. The optical channel can have any cross-section, including an annular cross-section.

The processing site is the site on the substrate where processing is performed. The processing site can be dot-shaped or be an area.

In this document, a microchannel is understood to be a tubular channel with a very small cross-section, for instance 10⁻² mm². The microchannel can be partially or entirely annular, elliptic, polygonal, helical or straight. This disclosure also uses the plural, microchannels, in which various not interconnected microchannels are to be comprised as well as various interconnected microchannels or different windings of a helical microchannel. The microchannel can be embodied as a double-walled channel, for instance in the form of a channel inside a channel and/or as a helical channel.

As a general rule, it is pointed out that within the framework of the present document, the indefinite numerals “one”, “two” etc. are normally not to be understood to mean “exactly one”, “exactly two” etc., but indefinite articles. A statement using the expressions “one . . . ”, “two . . . ” etc. is therefore to understood as meaning “at least one . . . ”, “at least two . . . ” etc. unless it becomes clear from the respective context that only “exactly one”, “exactly two” etc. can be intended. If the independent claim mentions “at least one”, this does not mean that the mention of “one . . . ”, “two . . . ” etc. in the dependent claims necessarily indicates exactly one, exactly two etc.

Within the framework of the present patent application, the expression “in particular” is always to be understood to introduce an optional, preferred characteristic. The expression is not to be understood in the sense of “namely”.

In a preferred embodiment, the at least one microchannel has a wall thickness, at least in one place, of less than 0.5 mm, preferably less than 0.3 mm and particularly preferably less than 0.2 mm. The microchannel is limited by a wall. The wall can form the border to the outside of the material feeding device or to another channel. This other channel can be an additional microchannel, a material feeding channel or an optical channel. It can also be an additional winding of a helical microchannel.

The low wall thickness of the microchannel allows a very small structural size of the material feeding device which nevertheless allows, for instance, temperature regulation.

In another preferred embodiment, the at least one microchannel is connected to a coolant supply. This supply can be, for instance, a pump with a temperature controller so that for effective temperature control, a temperature control medium, such as water or heat transfer oil, can be conveyed through the at least one microchannel at a defined temperature and a defined volume flow and/or pressure.

In a particularly preferred embodiment, the at least one microchannel has an integrated support. The support can cause a turbulence, or an increase in turbulence, in the temperature control medium flowing through the microchannel, and thus ensure optimized heat transfer. In addition, the support can also contribute to providing mechanical stability of the microchannel and of the material feeding device.

It has proven to be particularly effective if the at least one microchannel for cooling ensures a temperature control medium forward flow and a temperature control medium return flow. This ensures effectiveness of the temperature control of the material feeding device.

In another advantageous embodiment, the material feeding device has an area with a thread for receiving and fixing a nozzle tip into place, with microchannels cutting through the material feeding device at least except for the thread area. By increasing the area of the material feeding device where microchannels pass through, temperature control of the material feeding device is optimized. Due to provision of the thread, the nozzle tip, which is frequently subject to wear, can easily be replaced.

In another advantageous embodiment, a measurement sensor is provided in at least one microchannel. The microchannels cannot only be used for passing through a temperature control medium, but also for the introduction of measurement sensors. Such measurement sensors can be, for instance, temperature sensors for monitoring the temperature of the material feed, optical fibers for recording the weld pool temperature and/or for process control, sensors for distance measurement, for instance an optical fiber for OCT (optical coherence tomography, an imaging method for receiving two- and three-dimensional images from scattering materials in micrometer resolution), or measurement sensors for monitoring the material feed conveyance. By the introduction of such measurement sensors, process parameters can be monitored very closely to sites of interest in the interior of the material feeding device and/or to the processing site without a substantial change in size of the material feeding device.

Alternatively or in addition, an filler material influencing device can be provided in at least one microchannel. Such an influencing device can be, for instance, a device for preheating the filler material, for instance an inductive preheating unit. By preheating the material to be fed in, for instance the application rate of material, for example of filler material, can be increased. By introducing a material influencing device in a microchannel, the filler material influencing device can be approached, for example, very closely to the material feeding channel, in particular very closely to the processing site, so that the filler material can be influenced with high precision in a targeted manner.

It has proven to be advantageous if the manufacturing method for the material feeding device is from the method class of additive manufacturing. “Additive manufacturing” designates a process in which based on digital 3D construction data, a component is built up layer by layer by the deposition of material. The term “3D printing” is today often used as a synonym for additive manufacturing. However, “additive manufacturing” better describes that the method clearly differs from conventional, abrasive manufacturing methods. Instead of, for example, milling a workpiece from a solid block, additive manufacturing builds up components layer by layer from materials which are available, for instance, in the form of fine powder or wire. The materials can be different types of metals, plastics and composite materials. By having the material feeding device build up the structure layer by layer, geometries, in particular microchannels, can be produced which cannot be produced at all or only at great effort by conventional manufacturing methods.

A particularly advantageous technology for the manufacturing method has proven to be the laser-powder-bed-fusion (LPBF) technology. With this technology, the material to be processed is applied as a powder in a thin layer on a base plate. By laser irradiation, the powder material is locally melted completely, forming a rigid material layer after solidification. Subsequently, the base plate is lowered by the amount of one layer thickness and powder is re-applied. This cycle is repeated until all layers have been remelted. The finished component is cleaned from excess powder, processed as desired or used directly. The typical layer thicknesses for building up the component lie between 15 and 500 μm for all materials. The data for guiding the laser beam are generated from a 3D CAD body by means of a software. In the first calculation step, the component is divided into individual layers. In the second calculation step, the paths traced by the laser beam are created for each layer. To avoid contamination of the material with oxygen, the process commonly takes place under an inert gas atmosphere with argon or nitrogen. Components manufactured with LPBF are characterized by high specific densities >99%. In this manner, it is guaranteed that the mechanical properties of the generatively manufactured component largely correspond to those of the basis material.

It is explicitly pointed out that all numerical values indicated are not to be understood as exact values but that the actual values can be higher or lower on an engineering scale without leaving the described aspect of the invention.

Other advantages, particularities and useful further developments of the invention will become clear, by means of the figures, from the dependent claims and the following presentation of preferred examples of embodiment.

In the figures:

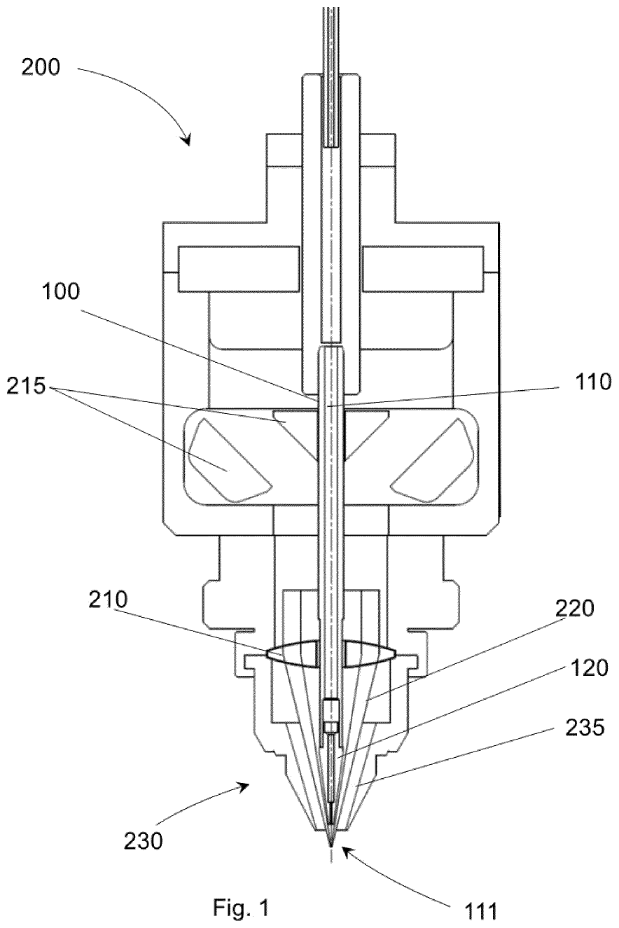

FIG. 1 shows a processing head of a material processing device,

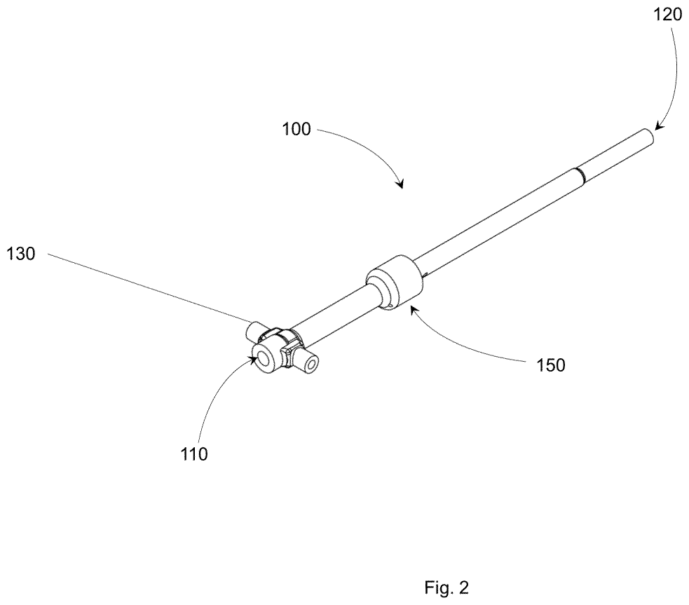

FIG. 2 is a three-dimensional presentation of a material feeding device according to the invention,

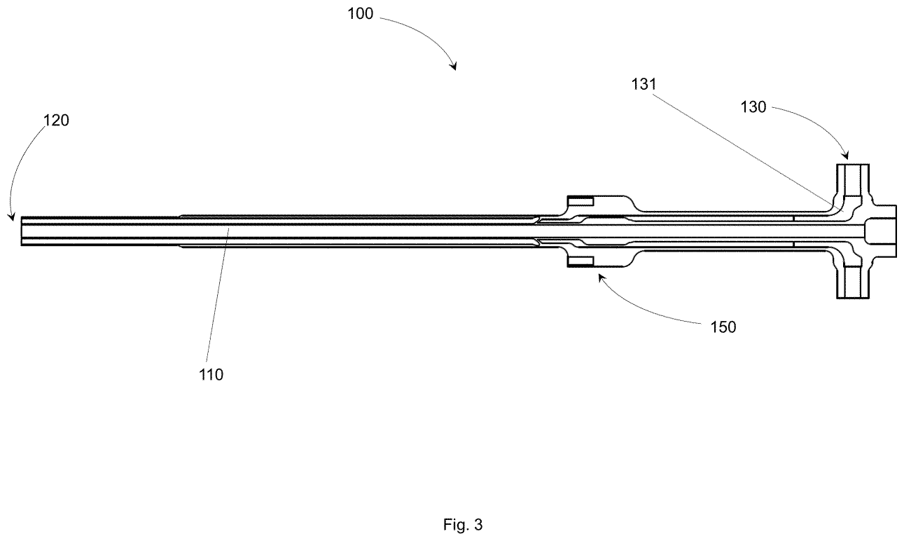

FIG. 3 is a longitudinal section of an embodiment of a material feeding device according to the invention,

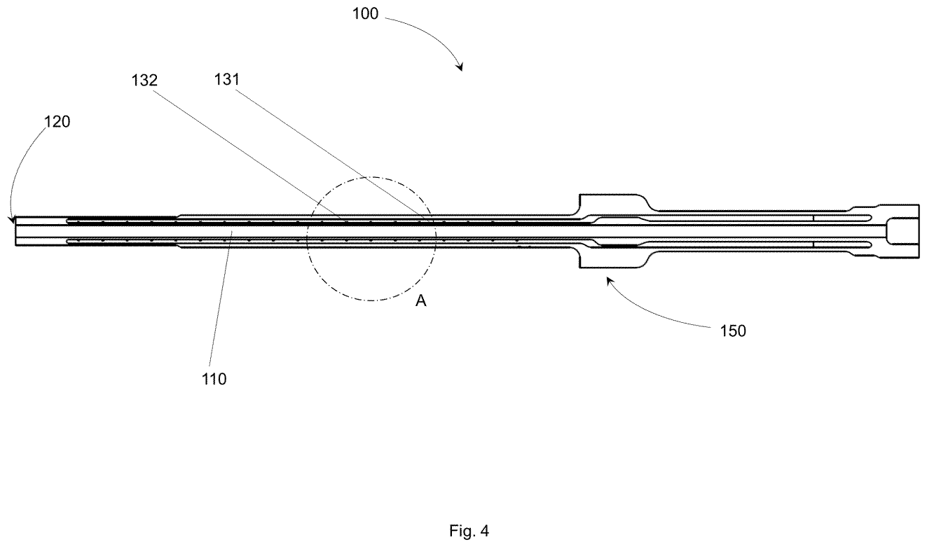

FIG. 4 is a longitudinal section of another embodiment of a material feeding device according to the invention,

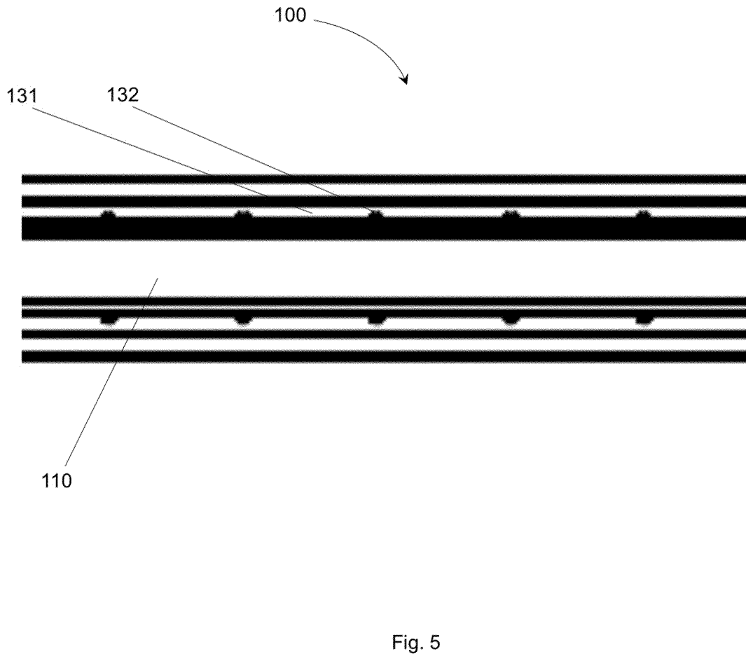

FIG. 5 is an enlarged cross-section of the material feeding device according to the invention from FIG. 4.

FIG. 1 shows a processing head 200 of a material processing device. The processing head 200 has a material feeding device 100 according to the invention with a material channel 110. The material feeding device according to the invention, to be used in a material processing device, has a material feeding channel 100 with an output end 111 which during operation of the material feeding device 100 faces a processing site. By means of the material feeding device 100, a material can be fed to a processing site on a substrate. The material processing device is used to perform material processing methods, for instance a laser welding method. The processing head 200 has a guiding device for laser beams. This guiding device has deflection units 215 for laser beams, for instance mirrors and/or prisms, a focusing lens 210 and further an inert gas nozzle 230 with an inert gas channel 235. Through the inert gas channel 235, inert gas is fed to the processing site. The inert gas prevents scaling of the substrate which is hot at the time of processing, or of the supplied material, respectively, by temporarily screening the processing site from contact with oxygen. In the embodiment shown, material is centrally, i. e. axially to the longitudinal axis of the processing head 200, fed to the processing site. For this purpose, if one or more laser beams are employed, the laser beam(s) must be divided such that the central axis becomes or remains free for material feeding. To achieve this, all components in the processing head, that is, in particular the material feeding device 100, must be embodied and the laser beam(s) must be conducted such in an optical channel 220 (in the embodiment shown in a laser-beam ring 220) that the beam guidance is not impaired, in particular such that the beam(s) is/are not shielded off. The material feeding channel 110 has at its end opposite the processing site an exchangeable material nozzle (not shown). This material nozzle can be, for instance, screwed into the material feeding channel 110. During operation, wear occurs on the end of the material feeding channel 110 opposite the processing site, among others due to the thermal load to which this end of the material feeding channel 110 is subjected during operation of the processing head 200. The exchangeable material nozzle can be easily replaced when wear has surpassed a critical limit. The material can be fed in solid, liquid or gaseous form. In solid form, it is generally a wire or a powder. If the material fed in has the form of a wire, for example, wear can result in an enlargement of the diameter of the material feeding channel 110 at the output end 111, impairing precision of the wire guidance.

FIG. 2 is a three-dimensional presentation of a material feeding device 100 according to the invention. The material feeding device 100 has a continuous material feeding channel 110 through which the material is fed to the processing site. Furthermore, the material feeding device 100 has media connecting ports 130. Via these media connecting ports 130, for instance a cooling medium, such as water, can be conducted into and out of the material feeding device 100. The media connecting ports 130 are located at the end of the material feeding device 100 which, during operation of the processing head 200, is opposite the processing site. In addition, the material feeding device 100 has a connecting port 120 for a material nozzle (not shown) which is arranged, during operation of the processing head 200, to be screwed into the end of the material feeding device 100 facing the processing site. Further, a connecting piece 150 can be seen in the Figure to which the material feeding device 100, which for manufacturing reasons has a two-part configuration, is attached. The material feeding device 100 is manufactured by means of an additive manufacturing method. If the parts to be manufactured in the additive manufacturing plant are limited in size, the material feeding device 100 can be manufactured in two or more parts and be assembled for operation at one or more connecting pieces 150. The material feeding device 100 can also be produced in one piece, however, provided that a respective additive manufacturing plant is available.

FIG. 3 is a longitudinal section of an embodiment of a material feeding device 100 according to the invention. As in FIG. 2, media connecting ports 130 and the connecting port 120 for the material nozzle can be seen, the presentation of the thread missing in this Figure for the purpose of clear presentation. The material feeding device 100 has a continuous material feeding channel 110. Furthermore, the material feeding device 100 has several media channels 131 which are operatively connected to the media connecting ports 130. For instance, a cooling medium, such as water, can be conducted into a medium channel 131 through a medium port 130. The medium channels 131 are embodied as microchannels 131, that is, as tubular channels with very small cross-sections, for instance 10⁻² mm². A microchannel 131 can be partly or entirely annular, elliptical, polygonal, helical or even straight. Several microchannels 131 can comprise both various microchannels 131 which are not interconnected and various interconnected microchannels 131 or different windings of a helical microchannel 131. A microchannel 131 can also be embodied as a double-walled channel, for instance as a channel inside a channel and/or as a helical channel. The microchannel 131 is limited by a wall. The wall can form the border to the outside of the material feeding device 100 or to another channel. This other channel can be an additional microchannel 131, a material feeding channel 110 or an optical channel 220. The additional microchannel 131 can also be an additional winding of a helical microchannel 131. Each microchannel 131 can have a wall thickness, at least in one place, of less than 0.5 mm, preferably less than 0.3 mm and particularly preferably less than 0.2 mm. The low wall thickness of the microchannel 131 allows a very small structural size of the material feeding device 100 which nevertheless allows, for instance, temperature regulation. Microchannels 131 cut through the material feeding device 100 at least except for the thread area for screwing the material nozzle (not shown in the Figure) into place. By increasing the area of the material feeding device 100 where microchannels 131 pass through, temperature control of the material feeding device 100 is optimized. It is also possible to introduce measurement sensors into one or more microchannels 131 of the material feeding device 100 close to the material feeding channel 110. Such measurement sensors can be, for instance, temperature sensors for monitoring the temperature of the material feed, optical fibers for recording the weld pool temperature and/or for process control, sensors for distance measurement, for instance an optical fiber for OCT (optical coherence tomography, an imaging method for receiving two- and three-dimensional images from scattering materials in micrometer resolution), or measurement sensors for monitoring the material feed conveyance. By the introduction of such measurement sensors, process parameters can be monitored very closely to sites of interest in the interior of the material feeding device 100 and/or to the processing site without a substantial change in size of the material feeding device 100.

Alternatively or in addition, an filler material influencing device can be provided in at least one microchannel 131. Such an influencing device can be, for instance, a device for preheating the filler material, for instance an inductive preheating unit. By preheating the material to be fed in, for instance the application rate of material, for example of filler material, can be increased. By introducing a material influencing device in a microchannel 131, the filler material influencing device can be approached, for example, very closely to the material feeding channel 110, in particular very closely to the processing site, so that the filler material can be influenced with high precision in a targeted manner.

The material feeding device 100 is manufactured by means of an additive manufacturing method. By constructing the material feeding device 100 in layers, geometries such as the microchannels 100 described above can be manufactured which cannot be manufactured at all or only at great effort with conventional manufacturing methods.

FIG. 4 shows a longitudinal section of another embodiment of a material feeding device 100 according to the invention. The microchannel 131 has an integrated support 132 or a plurality of such supports 132. The support 132 can ensure a turbulence or an increase in turbulence in the temperature control medium flowing through the microchannel 131 and thus ensure optimized heat transfer. In addition, the support 132 can also contribute to mechanical stability of the microchannel 131 and of the material feeding device 100.

FIG. 5 is an enlarged section of a material feeding device 100 according to the invention from FIG. 4. In this enlarged section, the supports 132 are easier to see. The supports 132 are applied on the interior, that is, on the side of the microchannel 131 facing the material feeding channel 110. The supports 132 can also be arranged, however, in any other place within the microchannel 131.

The embodiments shown here are only exemplary and are therefore not to be intended as limiting. Alternative embodiments considered by the person skilled in the art are equally comprised by the scope of protection of the present invention.

### LIST OF REFERENCE NUMBERS

100 material feeding device
110 material feeding channel
111 output end
120 connecting port for a material nozzle
130 medium connecting port
131 medium channel, microchannel
132 support
150 connecting piece
200 processing head
210 focusing lens
215 deflection unit
220 optical channel, laser beam ring
230 inert gas nozzle
235 inert gas channel

1. Material feeding device to be used in a material processing device, the material feeding device having at least one material feeding channel, the material feeding channel having an output end facing a processing site during operation of the material feeding device,
wherein;
the material feeding device has at least one microchannel, the at least one microchannel having, at least in one place, a wall thickness of less than 0.5 mm, and being connected to a coolant supply.

2. Material feeding device according to claim 1,
wherein;
the material feeding device has a central material feeding channel.

3. Material feeding device according to claim 1,
wherein;
the material feeding device has a material feeding channel arranged laterally at an angle larger than 0° and smaller than 90° to the axis of a beam guide.

4. Material feeding device according to claim 1,
wherein;
the at least one microchannel has an integrated support.

5. Material feeding device according to claim 1,
wherein;
the at least one micro-cooling channel ensures a temperature control medium forward flow and a temperature control medium return flow.

6. Material feeding device according to claim 1,
wherein;
the material feeding device has an area with a thread for receiving and fixing a nozzle tip into place, with microchannels cutting through the material feeding device at least except for the thread area.

7. Material feeding device according to claim 1,
wherein;
a measurement sensor is provided in at least one microchannel.

8. Material feeding device according to claim 1,
wherein;
a material influencing device is provided in at least one microchannel.

9. Manufacturing method for a material feeding device according to claim 1, wherein;
the manufacturing method is from the method class of additive manufacturing methods.

10. Manufacturing method according to claim 9,
wherein;
the manufacturing method uses laser powder bed fusion technology.

11. Material feeding device according to claim 1, wherein the wall thickness is less than 0.3 mm.

12. Material feeding device according to claim 1, wherein the wall thickness is less than 0.2 mm.
